(19) United States
(12) Patent Application Publication
(10) Pub. No.: US 2008/0143782 A1
(43) Pub. Date: Jun. 19, 2008

(54) INKJET DISPENSING APPARATUS

(75) Inventors: Po-Fu Chou, Taoyuan County (TW); Wei-Liang Hsu, Taipei City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/690,067

(22) Filed: Mar. 22, 2007

(30) Foreign Application Priority Data
Dec. 19, 2006 (TW) TW95147635

(51) Int. Cl. B41J 2/145

(52) U.S. Cl. 347/40

(57) ABSTRACT

An inkjet dispensing apparatus. The inkjet dispensing apparatus includes a cartridge body, a plurality of dispensing chips, a storage device, and at least a through hole. The dispensing chips are disposed on the cartridge body. The storage device comprises a plurality of storage sinks. The storage device is disposed above the cartridge body. Each storage sink is connected to each dispensing chip. The through hole penetrates the cartridge body.

### BACKGROUND OF THE INVENTION

1. Field of the Invention

The invention relates to an inkjet dispensing apparatus, and in particular to a inkjet dispensing apparatus comprising a plurality of dispensing chips and a particular cartridge which are capable of improving drying ability and producing uniform particles.

2. Description of the Related Art

Dispensing techniques are typically used in the drying apparatus for producing nano-particles. A conventional dispensing apparatus, however, does not typically comprise enough dispensing nozzles to produce a large quantity of nano-particles. A conventional dispensing cartridge device 1 is used in a dispensing process, as shown in FIG. 1. The dispensing cartridge device 1 comprises a dispensing chip 2 and a storage 3 disposed behind the dispensing chip 2. The dispensing cartridge device 1 is used to produce particles because it is inexpensive. The dispensing cartridge device 1, however, is not able to dispense a great quantity of liquid drops. Even when several cartridges are combined to produce a large quantity of particles, uniform particles and uniform drying ability are not achieved. Uniform drying ability can be achieved by using an air drying apparatus, as shown in FIG. 2. However, liquid drops are easily dried but cannot be produced to form nano-particles.

Thus, an inkjet dispensing apparatus with an increased number of the dispensing nozzles capable of generating uniform particles and uniform drying ability is desirable.

### BRIEF SUMMARY OF THE INVENTION

An inkjet dispensing apparatus is provided. The inkjet dispensing apparatus comprises a plurality of dispensing chips and a particular cartridge design, for producing nano-particles and enhancing drying ability.

An exemplary embodiment of an inkjet dispensing apparatus comprises a cartridge body, a plurality of dispensing chips, a storage device, and at least a through hole. The dispensing chips are disposed on the cartridge body. The storage device comprises a plurality of storage sinks. The storage device is disposed above the cartridge body. Each storage sink is connected with each dispensing chip. The through hole penetrates the cartridge body.

The dispensing chips are disposed on the cartridge body and can be spaced apart the same interval between each other. The through holes further comprise a plurality of storage passages, each storage passage is connected to each storage sink and each dispensing chip, providing flowing fluid therein. Each dispensing chip comprises a plurality of dispensing nozzles, disposed in several rows. The through holes comprise a plurality of ventilating holes, penetrating the cartridge body and providing air flow passing therethrough. The storage passages, ventilating holes, and dispensing chips are uniformly distributed on the cartridge body. The ventilating holes and the storage passages are spaced apart with the same interval between each other on the cartridge body.

The inkjet dispensing apparatus further comprises a plurality of connecting tubes connected to the storage sinks. The inkjet dispensing apparatus further comprises a constant temperature channel, disposed in the cartridge body, to maintain the interior temperature of the cartridge body. The cartridge body is a disc-shaped structure or an annular structure.

A detailed description is given in the following embodiments with reference to the accompanying drawings:

### BRIEF DESCRIPTION OF THE DRAWINGS

The invention can be more fully understood by reading the subsequent detailed description and examples with references made to the accompanying drawings, wherein:

FIG. 1 is a schematic view of a conventional dispensing device;

FIG. 2 is a schematic view of a conventional drying apparatus;

FIG. 3 is a schematic view of a first embodiment of an inkjet dispensing apparatus of the invention;

FIG. 4 is a schematic view in the direction of the arrow of FIG. 3;

FIG. 5 is a schematic view of a second embodiment of an inkjet dispensing apparatus of the invention;

FIG. 6 is a schematic view in the direction of the arrow of FIG. 5;

FIG. 7 is a schematic view of a third embodiment of an inkjet dispensing apparatus of the invention;

FIG. 8 is a schematic view in the direction of the arrow of FIG. 7;

FIG. 9 is a schematic view of a connecting tube of the third embodiment of the inkjet dispensing apparatus of the invention; and

FIG. 10 is a schematic view of a constant temperature channel of the third embodiment of the inkjet dispensing apparatus of the invention.

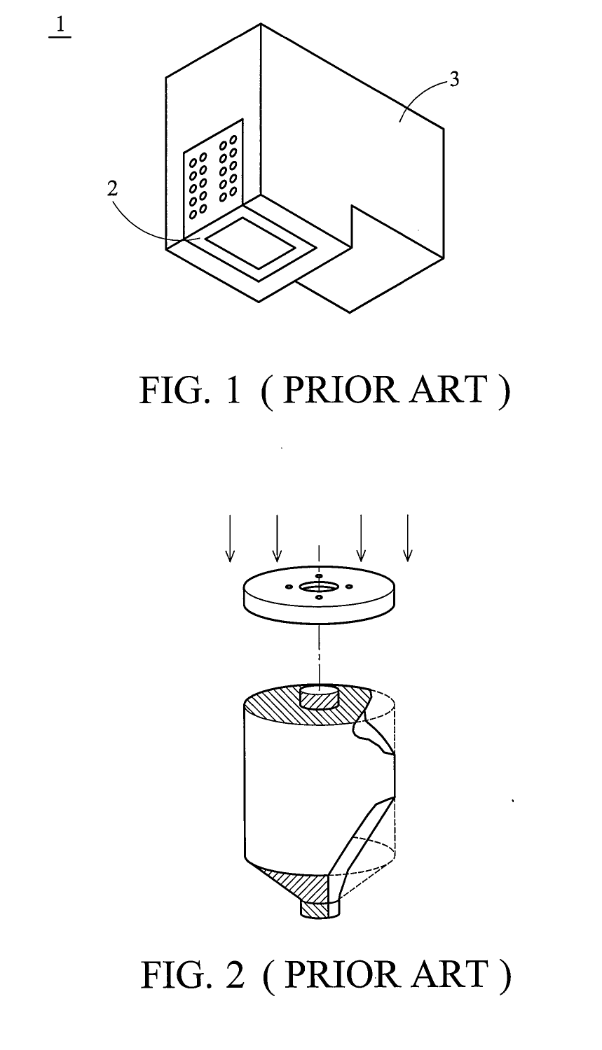

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### First Embodiment

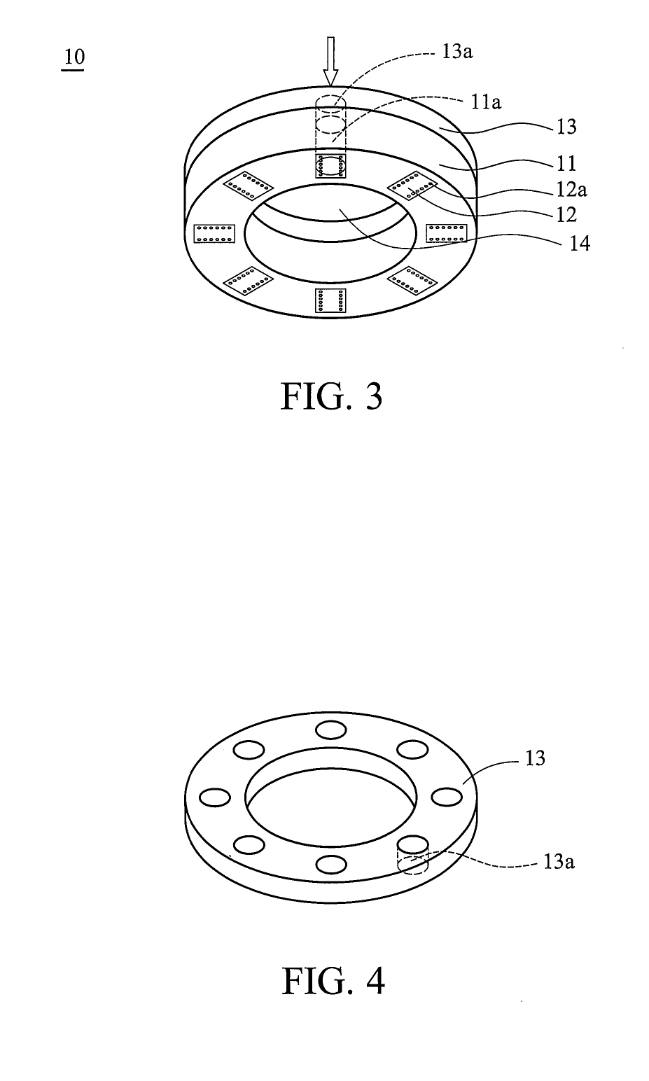

Referring to FIG. 3, a first embodiment of an inkjet dispensing apparatus 10 is an annular structure. The inkjet dispensing apparatus 10 comprises a cartridge body 11, eight dispensing chips 12, a storage device 13, and at least a through hole. Each dispensing chip 12 is spaced apart with the same interval between each other on the cartridge body 11 with annular structure. The storage device 13 is disposed on the cartridge body 11. The storage device 13 comprises eight storage sinks 13a, as shown in FIG. 4. The through hole further comprises eight storage passages 11a, wherein each storage passage 11a is connected with each dispensing chip 12 and each storage sink 13a. Additionally, each dispensing chip 12 comprises two rows of dispensing nozzles 12a, comprising twelve dispensing nozzles. Furthermore, the through hole further comprises a ventilating hole 14 penetrating the center of the cartridge body 11, wherein a dry air flow can pass through the ventilating hole 14.

The inkjet dispensing apparatus 10 is used in the air drying apparatus, as shown in FIG. 2, to produce nano-particles. First, the liquid in each storage sink 13a of the storage device 13 passes through each storage passage 11. Then, thermal bubble or piezoelectric actuator (not shown) of the dispensing chip 12 produces small liquid drops and these small liquid drops can be dispensed from each dispensing hole 12a. The air produced by the drying apparatus then passes through the ventilating hole 14 so that the liquid drops dispensed from the dispensing chip 12 can be uniformly dried. Thus, a great quantity of nano-particles can be produced, and the liquid drops from the dispensing nozzles are rapidly, and uniformly, dried.

Note that the number of the dispensing chips 12 and the number of the dispensing nozzles 12a are not limited to those shown in FIG. 3 and can be determined based on requirements. Additionally, the number of the ventilating holes is not limited.

Note that the number of the storage sinks 13a and the number of the storage passages 11a are not limited, but there should be as many storage sinks as storage passages.

### Second Embodiment

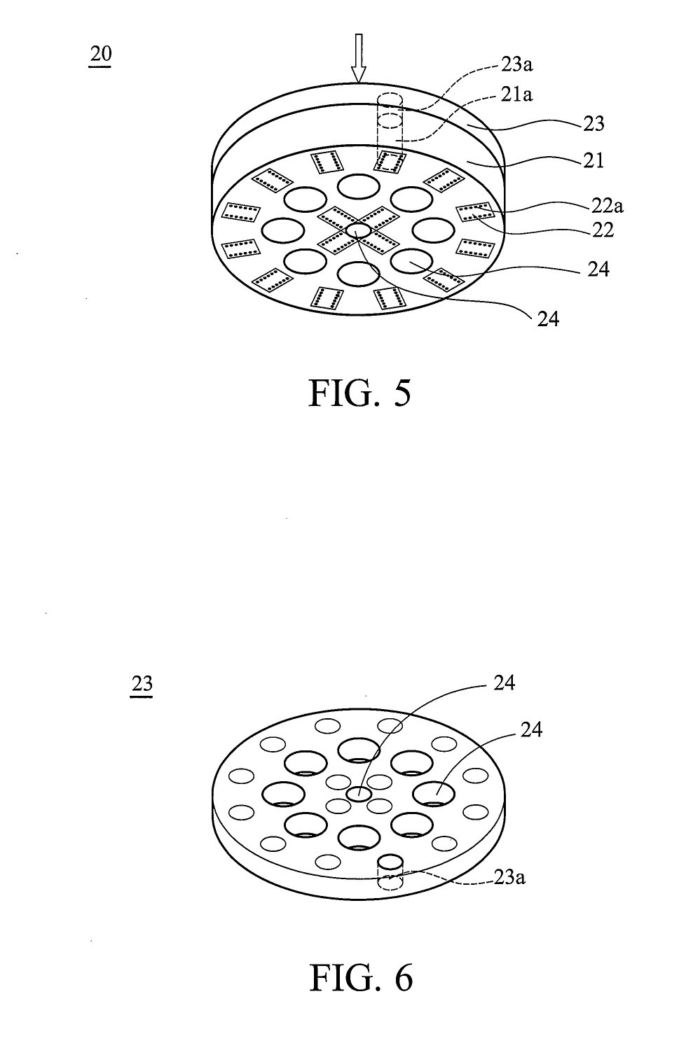

Referring to FIG. 5, a second embodiment of an inkjet dispensing apparatus 20 is a disc-shaped structure. The inkjet dispensing apparatus 20 comprises a cartridge body 21, sixteen dispensing chips 22, a storage device 23, and nine ventilating holes 24. Only the number and the arrangement of the dispensing chips 22 differ in the first and the second embodiments. Thus, the same description is omitted for brevity.

Twelve dispensing chips 22 are disposed along the periphery of the cartridge body 21, spaced apart with the same interval. The through hole of the cartridge body 21 comprises sixteen storage passages 21a, wherein each storage passage 21a is connected with each dispensing chip 22. The through hole further comprises eight ventilating holes 24. The ventilating holes 24 are disposed apart from each other by the same interval along the interior periphery of the dispensing chip 22. Another dispending chips 12 are disposed along the interior periphery of eight ventilating holes 24. Another ventilating hole 24 is disposed at the center of each of dispensing chip 22. As shown in FIG. 5, the interior and exterior periphery of the dispensing chips 22 are disposed apart with at least an interval, wherein the interval is at least equal or larger than the diameter of the ventilating hole 24.

Additionally, the dispensing nozzles 22a, the storage sinks 23a, and the storage passages 21a are identical with those of the first embodiment. Thus, the same description is omitted for brevity. Further, the function of the ventilating holes 24 is the same as in the previous embodiment; thus, description of thereof is also omitted.

The number of the dispensing chips 22 is more than that in the first embodiment, for enhancing the quantity. Additionally, the number of the ventilating holes 24 is increased and uniformly disposed for uniformly drying the particles, so that the particles are easily dried and the number of uniform particles is increased.

Note that the number of the dispensing chips 22 and the number of the dispensing nozzles 22a are not limited to those shown in FIG. 5 and may vary depending on the requirements. Additionally, the number of the ventilating holes 24 is not limited.

Note that the number of the storage sinks 23a and the number of the storage passages 21a are not limited, but there should be as many storage sinks as storage passages.

### Third Embodiment

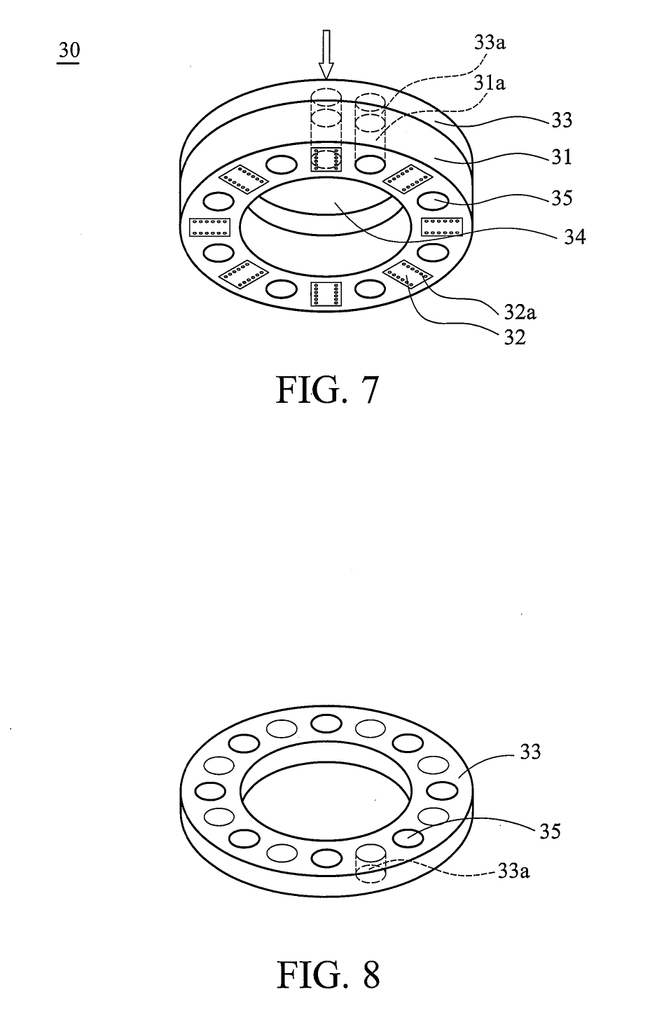

Referring to FIG. 7, a third embodiment of an inkjet dispensing apparatus 30 comprises a cartridge body 31, eights dispensing chips 32, a storage device 33, and a plurality of through holes. The inkjet dispensing apparatus 30 has an annular structure. Each dispensing chip 32 is spaced apart with the same interval between each other on the cartridge body 31 with annular structure. The through hole of the cartridge body 31 comprises eight storage passages 31a.

As shown in FIG. 8, the storage device 33 comprises eight storage sinks 33a, wherein each storage passage 31a is connected with each dispensing chip 32 and each storage sink 33a. Additionally, each dispensing chip 32 comprises two rows of dispensing nozzles 32a, which comprise twelve dispensing nozzles 32a.

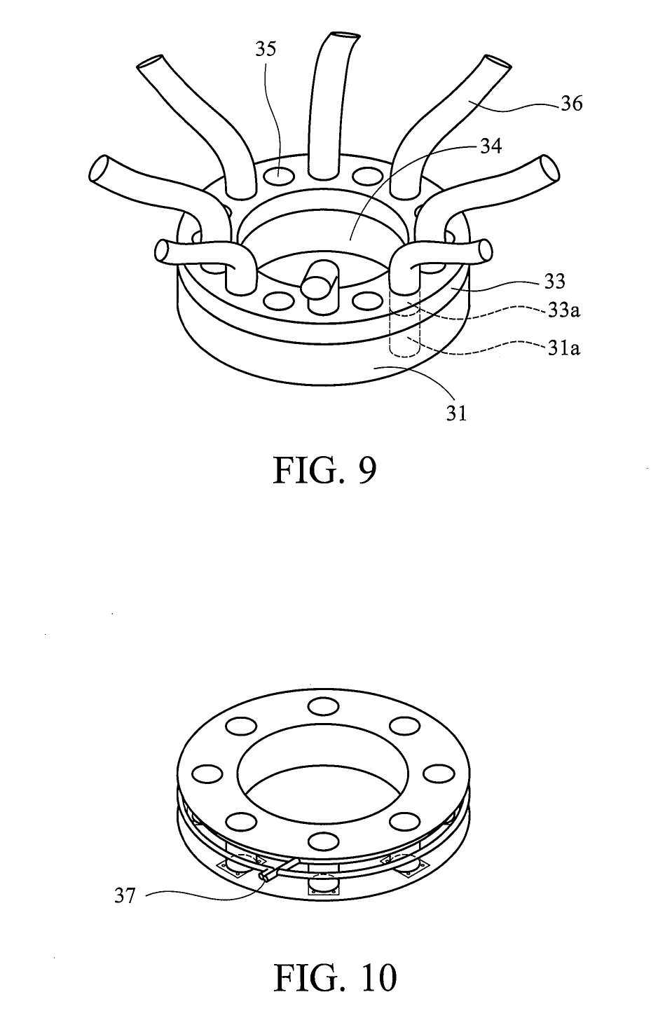

The through hole of the cartridge body 31 further comprises a center ventilating hole 34 and eight perimeter ventilating holes 35. Referring to FIG. 9 and FIG. 10, the inkjet dispensing apparatus 30 comprises a plurality of connecting tubes 36 and a constant temperature channel 37. Differences between the first embodiment and the third embodiment are the perimeter of ventilating hole 35, the connecting tube 36, and the constant temperature channel 37. Thus, the same description is omitted for brevity.

The center ventilating holes 34 are disposed on the cartridge body 31. Additionally, the perimeter ventilating holes 35 are disposed between each dispensing chip 32. Each connecting tube 36 is connected to each storage sink 33a, providing a great quantity of liquid flowing into the storage sink 33a, for enhancing production efficiency. Besides, the connecting tube 36 can also be connected with a pressure control device (not shown) for controlling the pressure in the cartridge body 31.

The inkjet dispensing apparatus 30 comprises a constant temperature channel 37. The constant temperature channel 37 is disposed in the cartridge body 31 for maintaining the temperature of the cartridge body 31.

The number of the through holes is far greater than in the first embodiment. Additionally, the connecting tubes 36 and the constant temperature channel 37 can be used to control the interior conditions of the cartridge body 31. Thus, when the quantity of dispensing particles is increased, particle distribution is more uniform and the drying ability is improved.

Note that the number of the dispensing chips 32, the dispensing nozzles 32a, and the ventilating holes (34 and 35) are not limited, and may vary depending on the requirement.

Note that the number of the storage sinks 33a and the storage passages 31a is not limited, but there should be as many storage sinks as storage passages.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An inkjet dispensing apparatus, comprising:
a cartridge body;
a plurality of dispensing chips disposed on the cartridge body;
a storage device comprising a plurality of storage sinks, disposed above the cartridge body, wherein each storage sink is connected with each dispensing chip; and
at least a through hole penetrating the cartridge body.

2. The inkjet dispensing apparatus as claimed in claim 1, wherein the dispensing chips are spaced apart the same interval between each other on the cartridge body.

3. The inkjet dispensing apparatus as claimed in claim 1, wherein the through holes further comprise a plurality of storage passages, and each storage passage is connected to each storage sink and each dispensing chip, providing flowing fluid therein.

4. The inkjet dispensing apparatus as claimed in claim 3, wherein each dispensing chip comprises a plurality of dispensing nozzles, disposed in several rows.

5. The inkjet dispensing apparatus as claimed in claim 3, wherein the through holes comprise a plurality of ventilating holes, and the ventilating holes penetrate the cartridge body and provide air flow passing through.

6. The inkjet dispensing apparatus as claimed in claim 5, wherein the storage passages, the ventilating holes, and the dispensing chips are uniformly distributed on the cartridge body.

7. The inkjet dispensing apparatus as claimed in claim 5, wherein the ventilating holes and the storage passages are spaced apart with the same interval between each other on the cartridge body.

8. The inkjet dispensing apparatus as claimed in claim 1, further comprising a plurality of connecting tubes connecting with the storage sinks.

9. The inkjet dispensing apparatus as claimed in claim 1, further comprising a constant temperature channel, disposed in the cartridge body, to maintain the interior temperature of the cartridge body.

10. The inkjet dispensing apparatus as claimed in claim 1, wherein the cartridge body is a disc-shaped structure.

11. The inkjet dispensing apparatus as claimed in claim 1, wherein the cartridge body is an annular structure.
